(19) United States
(12) Patent Application Publication
(10) Pub. No.: US 2018/0204517 A1
(43) Pub. Date: Jul. 19, 2018

(54) AMOLED DISPLAY DRIVE METHOD, DRIVE CIRCUIT AND DISPLAY DEVICE

(71) Applicant: Shenzhen China Star Optoelectronics Technology Co., Ltd., Shenzhen, Guangdong (CN)

(72) Inventors: Ping-sheng KUO, Shenzhen, Guangdong (CN); Li-wei CHU, Shenzhen, Guangdong (CN)

(73) Assignee: Shenzhen China Star Optoelectronics Technology Co., Ltd., Shenzhen, Guangdong (CN)

(21) Appl. No.: 15/301,266

(22) PCT Filed: Aug. 31, 2016
(86) PCT No.: PCT/CN2016/097527

§ 371 Date: Sep. 30, 2016

(30) Foreign Application Priority Data
Aug. 19, 2016 (CN) 201610692714.2

(51) Int. Cl. G09G 3/3258; G09G 3/20

(52) U.S. Cl. CPC G09G 3/3258; G09G 2310/0264; G09G 3/2074

(57) ABSTRACT

Provided are an AMOLED display drive method and a drive circuit. The drive method comprises detecting whether a gray scale of a preset region in the AMOLED display is larger than a preset gray scale, and detecting whether pixel amounts corresponded with a width and a length of the preset region are larger than preset pixel amounts; calculating a condition that a threshold voltage of each drive thin film transistor of the preset region changes along with time in a preset duration; compensating a data signal loaded to the thin film transistor according to the condition that the threshold voltage of the drive thin film transistor of the preset region changes along with time to make a variation of the data signal along with time equal to a variation of the threshold voltage along with time; using the data signal after being compensated to drive the AMOLED display.

### CROSS REFERENCE

This application claims the priority of Chinese Patent Application No. 201610692714.2, entitled “AMOLED display drive method, drive circuit and display device”, filed on Aug. 19, 2016, the disclosure of which is incorporated herein by reference in its entirety.

### FIELD OF THE INVENTION

The present invention relates to a display field, and more particularly relates to an AMOLED display drive method, an AMOLED drive circuit and an AMOLED display device.

### BACKGROUND OF THE INVENTION

Please refer to FIG. 1. The drive circuit of one sub pixel in the AMOLED display comprises a switching thin film transistor (Switching TFT) T1, a driving thin film transistor (Driving TFT) T2 and a storage capacitor C. The gate of the switching thin film transistor T1 is electrically coupled to the scan signal line to receive the scan signal, and is on or off under control of the scan signal. The drain of the switching thin film transistor T1 is electrically coupled to the data line to receive the data signal. As the switching thin film transistor T1 is on under the control of the scan signal, the data signal is transmitted to the source of the switching thin film transistor T1 through the drain of the switching thin film transistor T1. The gate of the driving thin film transistor T2 is electrically coupled to the source of the switching thin film transistor T1. The drain of the driving thin film transistor T2 is electrically coupled to one power source Ovdd. The source of the driving thin film transistor T2 is electrically coupled to the positive electrode of the organic light emitting diode OLED. The negative electrode of the organic light emitting diode OLED is grounded OVSS. As the switching thin film transistor T1 is on, the driving thin film transistor T2 receives the data signal, and drives the organic light emitting diode OLED under control of the data signal. One end of the storage capacitor C is electrically coupled to the gate of the driving thin film transistor T2, and one end is electrically coupled to the drain of the driving thin film transistor T2. The node which electrically connects the storage capacitor C and the gate of the drive thin film transistor T2 is named as P. The drive circuit structure as aforementioned is so called the 2T1C structure because it comprises two thin film transistors and one capacitor. Under various gray scales, the voltages of the P point are different but the voltage of the P point is larger than the voltage of OVSS. As an illustration, as the gray scale is 255, the voltage of the P point is equal to GM1, and as the gray scale is 0, the voltage of the P point is equal to GM9, and GM1 is larger than GM9. Please refer to FIG. 2. The gray scale of the A region in the left picture of FIG. 2 is 255, and the gray scale of the B region is 0. Then, the conditions of the voltages V_{GS} between the gates and the sources of the drive thin film transistors T2 in the A region and the B region are: V_{GS}_{_}A>V_{GS}_{_}B.

Consequently, the stress of the A region is always larger than the stress of the B region. Therefore, after the image in the left picture of FIG. 2 shows for a period of time, and then switches to full gray scale, the serious image sticking happens as shown in the right picture of FIG. 2. Accordingly, it results in the image sticking appearance which is more serious for the AMOLED display.

### SUMMARY OF THE INVENTION

The present invention provides an AMOLED display drive method, employed to drive an AMOLED display, wherein the AMOLED display drive method comprises:

detecting whether a gray scale of a preset region in the AMOLED display is larger than a preset gray scale, and detecting whether pixel amounts corresponded with a width and a length of the preset region are larger than preset pixel amounts;

calculating a condition that a threshold voltage of each drive thin film transistor of the preset region changes along with time in a preset duration as the gray scale of the preset region in the AMOLED display is larger than the preset gray scale, and both the pixel amounts corresponded with the width and the length of the preset region are larger than the preset pixel amounts;

compensating a data signal loaded to the thin film transistor according to the condition that the threshold voltage of the drive thin film transistor of the preset region changes along with time in the preset duration to make a variation of the data signal loaded to the drive thin film transistor along with time equal to a variation of the threshold voltage of the drive thin film transistor along with time;

using the data signal after being compensated to drive the AMOLED display.

As the gray scale of the preset region in the AMOLED display is smaller than or equal to the preset gray scale, or the amount corresponded with the width of the preset region is smaller than or equal to the preset pixel amount, or the amount corresponded with the length of the preset region is smaller than or equal to the preset pixel amount, the data signal is not required to be compensated, and the data signal is used to drive the AMOLED display.

The preset region is an arbitrary region in the AMOLD display.

The present invention further provides an AMOLED display drive circuit, employed to drive an AMOLED display, wherein the AMOLED display drive circuit comprises:

a detection unit, employed for detecting whether a gray scale of a preset region in the AMOLED display is larger than a preset gray scale, and detecting whether pixel amounts corresponded with a width and a length of the preset region are larger than preset pixel amounts;

a calculation unit, calculating a condition that a threshold voltage of a drive thin film transistor of the preset region changes along with time in a preset duration as the gray scale of the preset region in the AMOLED display is larger than the preset gray scale, and both the pixel amounts corresponded with the width and the length of the preset region are larger than the preset pixel amounts;

a compensation unit, employed for compensating a data signal loaded to the thin film transistor according to the condition that the threshold voltage of the drive thin film transistor of the preset region changes along with time in the preset duration to make a variation of the data signal loaded to the drive thin film transistor along with time equal to a variation of the threshold voltage of the drive thin film transistor along with time;

a drive unit, employed for using the data signal after being compensated to drive the AMOLED display.

As the gray scale of the preset region in the AMOLED display is smaller than or equal to the preset gray scale, or the amount corresponded with the width of the preset region is smaller than or equal to the preset pixel amount, or the amount corresponded with the length of the preset region is smaller than or equal to the preset pixel amount, the data signal is not required to be compensated by further employing the drive unit, and the data signal is used to drive the AMOLED display.

The preset region is an arbitrary region in the AMOLD display.

The present invention further provides an AMOLED display device, wherein the AMOLED display device comprises an AMOLED display drive circuit, and the AMOLED display drive circuit is employed to drive an AMOLED display, and the AMOLED display drive circuit comprises:

a detection unit, employed for detecting whether a gray scale of a preset region in the AMOLED display is larger than a preset gray scale, and detecting whether pixel amounts corresponded with a width and a length of the preset region are larger than preset pixel amounts;

a calculation unit, calculating a condition that a threshold voltage of each drive thin film transistor of the preset region changes along with time in a preset duration as the gray scale of the preset region in the AMOLED display is larger than the preset gray scale, and both the pixel amounts corresponded with the width and the length of the preset region are larger than the preset pixel amounts;

a compensation unit, employed for compensating a data signal loaded to the thin film transistor according to the condition that the threshold voltage of the drive thin film transistor of the preset region changes along with time in the preset duration to make a variation of the data signal loaded to the drive thin film transistor along with time equal to a variation of the threshold voltage of the drive thin film transistor along with time;

a drive unit, employed for using the data signal after being compensated to drive the AMOLED display.

As the gray scale of the preset region in the AMOLED display is smaller than or equal to the preset gray scale, or the amount corresponded with the width of the preset region is smaller than or equal to the preset pixel amount, or the amount corresponded with the length of the preset region is smaller than or equal to the preset pixel amount, the data signal is not required to be compensated, and the data signal is used to drive the AMOLED display.

The preset region is an arbitrary region in the AMOLD display.

In comparison with prior art, in the AMOLED display drive method of the present invention, as the gray scale of the preset region in the AMOLED display is larger than the preset gray scale, and both the pixel amounts corresponded with the width and the length of the preset region are larger than the preset pixel amounts, the data signal loaded to the thin film transistor is compensated according to the condition that the threshold voltage of the drive thin film transistor of the preset region changes along with time in the preset duration to make a variation of the data signal loaded to the drive thin film transistor along with time equal to a variation of the threshold voltage of the drive thin film transistor along with time. Thus, the current flowing through the organic light emitting diode remains unchanged, and thus to achieve the technical effect of reducing the image sticking of the AMOLED display.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a circuit diagram of a drive circuit of one sub pixel in an AMOLED display in prior art.

FIG. 2 is a diagram that the image residue generates in A region relative to B region as the drive circuit in FIG. 1 is applied in the AMOLED display.

FIG. 3 is a circuit diagram of a drive circuit of one sub pixel in an AMOLED display according to one preferred embodiment of the present invention.

FIG. 4 is a flowchart of an AMOLED display drive method according to one preferred embodiment of the present invention.

FIG. 5 is a circuit block diagram of an AMOLED display drive circuit according to one preferred embodiment of the present invention.

FIG. 6 is an AMOLED display device according to one preferred embodiment of the present invention.

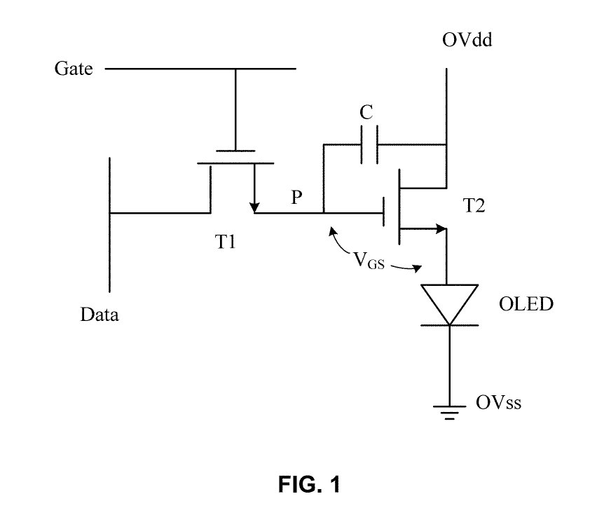

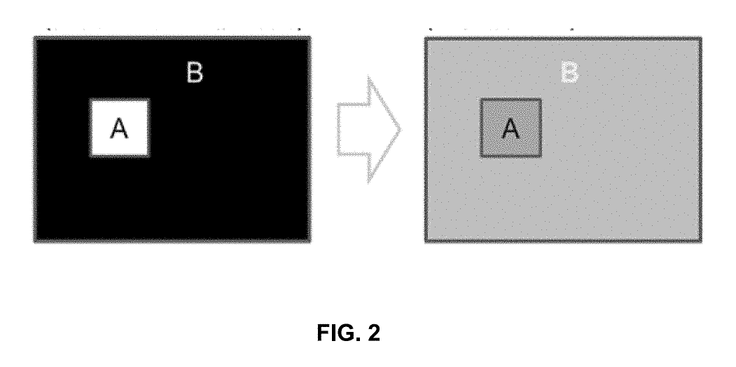

### DETAILED DESCRIPTION OF PREFERRED EMBODIMENTS

Embodiments of the present invention are described in detail with the technical matters, structural features, achieved objects, and effects with reference to the accompanying drawings as follows. It is clear that the described embodiments are part of embodiments of the present invention, but not all embodiments. Based on the embodiments of the present invention, all other embodiments to those of ordinary skill in the premise of no creative efforts obtained, should be considered within the scope of protection of the present invention.

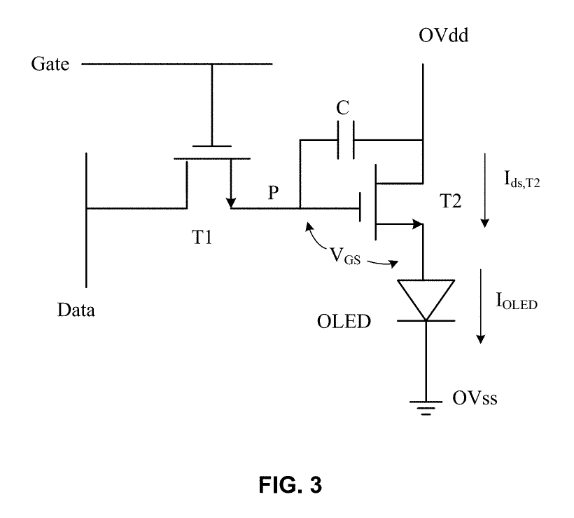

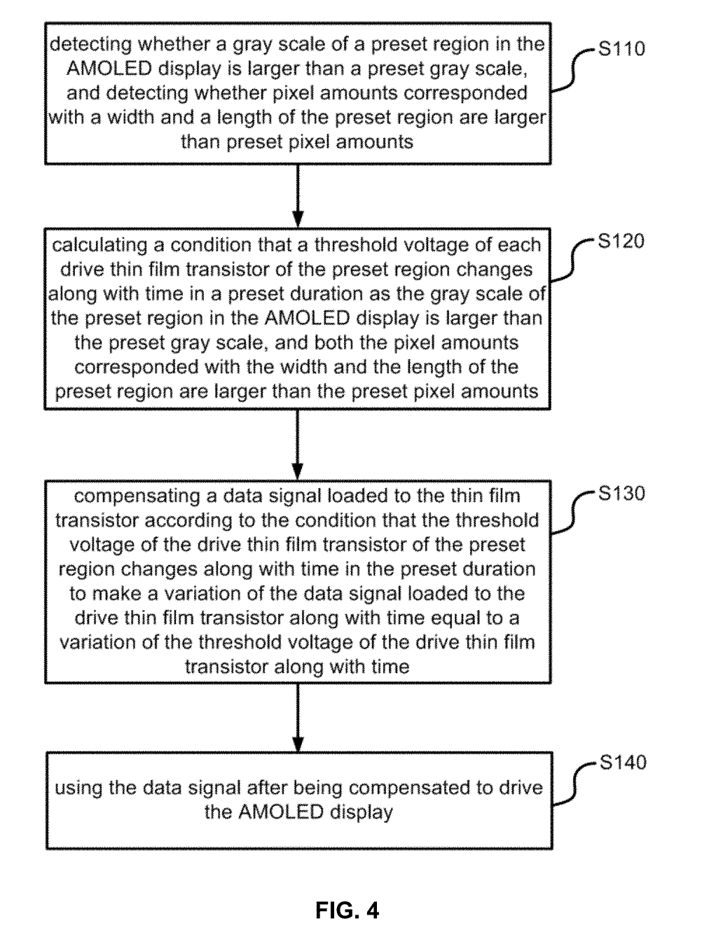

Please refer to FIG. 3 and FIG. 4, together. FIG. 3 is a circuit diagram of a drive circuit of one sub pixel in an AMOLED display according to one preferred embodiment of the present invention. FIG. 4 is a flowchart of an AMOLED display drive method according to one preferred embodiment of the present invention. The drive circuit of one sub pixel in the AMOLED display comprises a switching thin film transistor (Switching TFT) T1, a driving thin film transistor (Driving TFT) T2 and a storage capacitor C. The gate of the switching thin film transistor T1 is electrically coupled to the scan signal line to receive the scan signal, and is on or off under control of the scan signal. The drain of the switching thin film transistor T1 is electrically coupled to the data line to receive the data signal. As the switching thin film transistor T1 is on under the control of the scan signal, the data signal is transmitted to the source of the switching thin film transistor T1 through the drain of the switching thin film transistor T1. The gate of the driving thin film transistor T2 is electrically coupled to the source of the switching thin film transistor T1. The drain of the driving thin film transistor T2 is electrically coupled to one power source Ovdd. The source of the driving thin film transistor T2 is electrically coupled to the positive electrode of the organic light emitting diode OLED. The negative electrode of the organic light emitting diode OLED is grounded OVSS. As the switching thin film transistor T1 is on, the driving thin film transistor T2 receives the data signal, and drives the organic light emitting diode OLED under control of the data signal. One end of the storage capacitor C is electrically coupled to the gate of the driving thin film transistor T2, and one end is electrically coupled to the drain of the driving thin film transistor T2. The drive circuit structure as aforementioned is so called the 2T1C structure because it comprises two thin film transistors and one capacitor. It can be understood that the 2T1C structure drive circuit is illustrated for description in the present invention. However, the present invention is not restricted to the 2T1C structure drive circuit.

The AMOLED display drive method further comprises the following steps but is not restricted thereto.

Step S110, detecting whether a gray scale of a preset region in the AMOLED display is larger than a preset gray scale, and detecting whether pixel amounts corresponded with a width and a length of the preset region are larger than preset pixel amounts. In one embodiment, the preset gray scale can be: as the AMOLED display is 8 bit, the preset gray scale is 160. In one embodiment, the preset pixel amount is equal to 15. In one embodiment, the preset region is an arbitrary region in the AMOLD display.

Step S120, calculating a condition that a threshold voltage of each drive thin film transistor of the preset region changes along with time in a preset duration as the gray scale of the preset region in the AMOLED display is larger than the preset gray scale, and both the pixel amounts corresponded with the width and the length of the preset region are larger than the preset pixel amounts. For each drive thin film transistor T2 in the preset region, the semi experience equation of the variation condition Vₜₕ₍ₜ₎ of the threshold voltage of the drive thin film transistor T2 along with time is shown by equation (1).

Vₜₕ₍ₜ₎=Vₜₕ,0+ΔVₜₕ(t) (equation 1)

and,

ΔVₜₕ(t)=A·exp(−E_{A}/kT)·t^{β}(V_{GS}−ηV_{DS}−V_{th,0})ⁿ (equation 2)

Wherein ΔVₜₕ(t) represents a variation of the threshold voltage of the drive thin film transistor T2 along with time. Thus, ΔVₜₕ(t) is a function of V_{GS}, V_{DS} and time.

For the particular manufacture process of the AMOLED display, both A and β are constants. The more excellent the manufacture process is, A is smaller and β is smaller, too. EA is the Activation Energy. For the particular manufacture process of the AMOLED display, EA is a constant.

V_{th,0}:Tₜₕ in t=0, and η=V_{GS}/(V_{GS}+V_{DS})

wherein V_{GS} is the voltage between the gate and the source of the drive thin film transistor T2; V_{DS} is the voltage between the drain and the source of the drive thin film transistor T2. The equation that the current I_{OLED} flowing through the organic light emitting diode OLED changes along with time is shown by equation (3).

$${I}_{OLED} ( t ) = {I}_{ds , T 2} = 1 \text{/} 2 {μ}_{n} Cox ( W \text{/} L ) {( {V}_{GS} - {V}_{th} )}^{2} = 1 \text{/} 2 {μ}_{n} Cox ( W \text{/} L ) {( {V}_{data} ( t ) - {V}_{S} - {V}_{th} ( t ) )}^{2} \qquad equation ( 3 )$$

wherein I_{ds,T2} means the current between the source and the drain of the drive thin film transistor T2; μₙ means the carrier mobility of the channel layer of the drive thin film transistor T2; Cox means the capacitance of the gate insulation layer unit area in the drive thin film transistor T2; W means the width of the channel layer of the drive thin film transistor T2; L means the length of the channel layer side of the drive thin film transistor T2; V_{data(f)} means the variation condition that the data signal changes along with time.

Step S130, compensating a data signal loaded to the thin film transistor according to the condition that the threshold voltage of the drive thin film transistor of the preset region changes along with time in the preset duration to make a variation of the data signal loaded to the drive thin film transistor along with time equal to a variation of the threshold voltage of the drive thin film transistor along with time.

Specifically, the data signal loaded to each thin film transistor is compensated according to the condition that the threshold voltage of each drive thin film transistor of the preset region changes along with time in the preset duration to make the variation of the data signal loaded to each drive thin film transistor along with time equal to the variation of the threshold voltage of the drive thin film transistor along with time.

As being told from equation (3), for each drive thin film transistor in the preset region, the current I_{OLED(t)} flowing through the organic light emitting diode OLED is relevant with the variation condition Vₜₕ₍ₜ₎ of the threshold voltage of the drive thin film transistor T2 along with time and the variation condition V_{data(t)} of the data signal along with time. If the variation condition Vₜₕ₍ₜ₎ of the threshold voltage of the drive thin film transistor T2 along with time is equal to the variation condition V_{data(t)} of the data signal along with time, i.e. ΔVₜₕ₍ₜ₎=ΔV_{data(t)}, the current I_{OLED} flowing through the organic light emitting diode OLED stops changing along with time, and thus to achieve the technical effect of reducing the image sticking of the AMOLED display.

Step S140, using the data signal after being compensated to drive the AMOLED display.

The AMOLED display drive method further comprises the following steps.

Step I, as the gray scale of the preset region in the AMOLED display is smaller than or equal to the preset gray scale, or the amount corresponded with the width of the preset region is smaller than or equal to the preset pixel amount, or the amount corresponded with the length of the preset region is smaller than or equal to the preset pixel amount, the data signal is not required to be compensated, and the data signal is used to drive the AMOLED display.

In comparison with prior art, in the AMOLED display drive method of the present invention, as the gray scale of the preset region in the AMOLED display is larger than the preset gray scale, and both the pixel amounts corresponded with the width and the length of the preset region are larger than the preset pixel amounts, the data signal loaded to the thin film transistor is compensated according to the condition that the threshold voltage of the drive thin film transistor of the preset region changes along with time in the preset duration to make a variation of the data signal loaded to the drive thin film transistor along with time equal to a variation of the threshold voltage of the drive thin film transistor along with time. Thus, the current flowing through the organic light emitting diode remains unchanged, and thus to achieve the technical effect of reducing the image sticking of the AMOLED display.

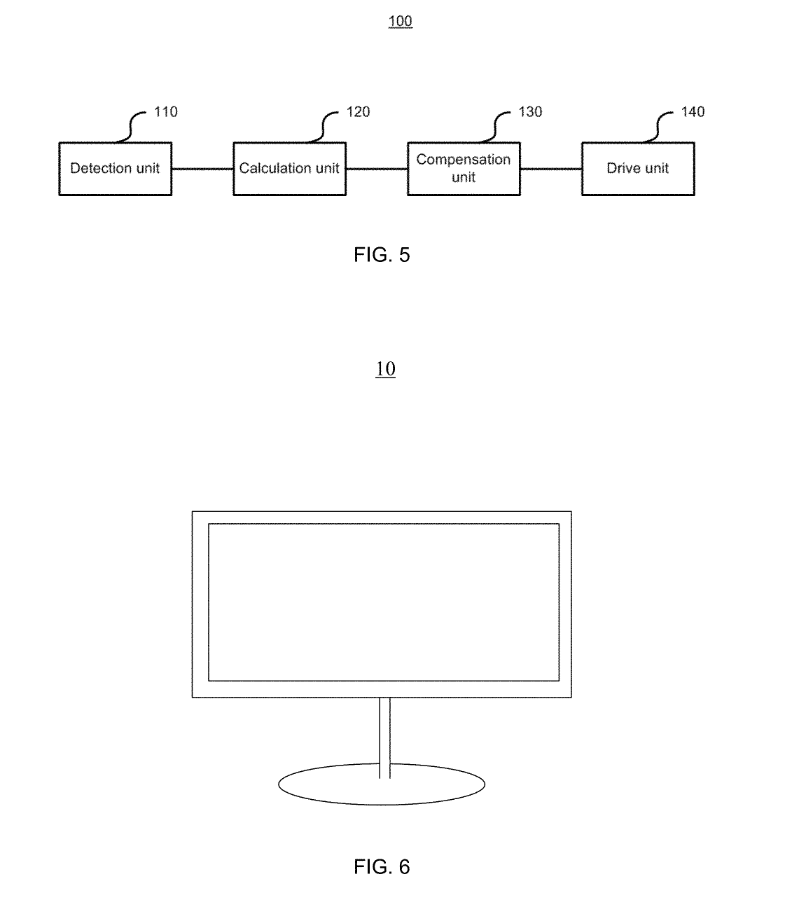

The following is the description for the AMOLED display drive circuit of the present invention with combination of FIG. 3, FIG. 4 and the previous description for the drive circuit of one sub pixel in the AMOLED display and the AMOLED display drive method. Please refer to FIG. 5. FIG. 5 is a circuit block diagram of an AMOLED display drive circuit according to one preferred embodiment of the present invention. The AMOLED display drive circuit 100 comprises a detection unit 110, a calculation unit 120, a compensation unit 130 and a drive unit 140. The specific functions of the respective units are introduced in detail below.

The detection unit 110 is employed for detecting whether a gray scale of a preset region in the AMOLED display is larger than a preset gray scale, and detecting whether pixel amounts corresponded with a width and a length of the preset region are larger than preset pixel amounts. In one embodiment, the preset gray scale can be: as the AMOLED display is 8 bit, the preset gray scale is 160. In one embodiment, the preset pixel amount is equal to 15. In one embodiment, the preset region is an arbitrary region in the AMOLD display.

The calculation unit 120 calculates a condition that a threshold voltage of the drive thin film transistor of the preset region changes along with time in a preset duration as the gray scale of the preset region in the AMOLED display is larger than the preset gray scale, and both the pixel amounts corresponded with the width and the length of the preset region are larger than the preset pixel amounts. Specifically, please refer to the description in the Step S120 for that the calculation unit 120 calculates the condition that the threshold voltage of the drive thin film transistor of the preset region changes along with time in the preset duration. The repeated description is omitted here.

The compensation unit 130 is employed for compensating a data signal loaded to the thin film transistor according to the condition that the threshold voltage of the drive thin film transistor of the preset region changes along with time in the preset duration to make a variation of the data signal loaded to the drive thin film transistor along with time equal to a variation of the threshold voltage of the drive thin film transistor along with time. Specifically, as being told from equation (3), the current I_{OLED(t)} flowing through the organic light emitting diode OLED is relevant with the variation condition Vₜₕ₍ₜ₎ of the threshold voltage of the drive thin film transistor T2 along with time and the variation condition V_{data(t)} of the data signal along with time. If the variation condition Vₜₕ₍ₜ₎ of the threshold voltage of the drive thin film transistor T2 along with time is equal to the variation condition V_{data(t)} of the data signal along with time, i.e. ΔVₜₕ₍ₜ₎=ΔV_{data(t)}, the current I_{OLED} flowing through the organic light emitting diode OLED stops changing along with time, and thus to achieve the technical effect of reducing the image sticking of the AMOLED display. The drive unit 140 is employed for using the data signal after being compensated to drive the AMOLED display.

It can be understood that the detection unit 110, the calculation unit 120, the compensation unit 130 and the drive unit 140 are integrated inside the TCON.

In this embodiment, as the gray scale of the preset region in the AMOLED display is smaller than or equal to the preset gray scale, or the amount corresponded with the width of the preset region is smaller than or equal to the preset pixel amount, or the amount corresponded with the length of the preset region is smaller than or equal to the preset pixel amount, the data signal is not required to be compensated by further employing the drive unit 140, and the data signal is used to drive the AMOLED display.

Please refer to FIG. 6. FIG. 6 is an AMOLED display device according to one preferred embodiment of the present invention. The AMOLED display device 1 comprises the AMOLED display drive circuit 100. The AMOLED display drive circuit 100 is employed to drive the AMOLED display. The AMOLED display drive circuit 100 is as aforementioned. The repeated description is omitted here.

Above are embodiments of the present invention, which does not limit the scope of the present invention. Any modifications, equivalent replacements or improvements within the spirit and principles of the embodiment described above should be covered by the protected scope of the invention.

What is claimed is:

1. An AMOLED display drive method, employed to drive an AMOLED display, wherein the AMOLED display drive method comprises:
detecting whether a gray scale of a preset region in the AMOLED display is larger than a preset gray scale, and detecting whether pixel amounts corresponded with a width and a length of the preset region are larger than preset pixel amounts;
calculating a condition that a threshold voltage of each drive thin film transistor of the preset region changes along with time in a preset duration as the gray scale of the preset region in the AMOLED display is larger than the preset gray scale, and both the pixel amounts corresponded with the width and the length of the preset region are larger than the preset pixel amounts;
compensating a data signal loaded to the thin film transistor according to the condition that the threshold voltage of the drive thin film transistor of the preset region changes along with time in the preset duration to make a variation of the data signal loaded to the drive thin film transistor along with time equal to a variation of the threshold voltage of the drive thin film transistor along with time;
using the data signal after being compensated to drive the AMOLED display.

2. The AMOLED display drive method according to claim 1, wherein as the gray scale of the preset region in the AMOLED display is smaller than or equal to the preset gray scale, or the amount corresponded with the width of the preset region is smaller than or equal to the preset pixel amount, or the amount corresponded with the length of the preset region is smaller than or equal to the preset pixel amount, the data signal is not required to be compensated, and the data signal is used to drive the AMOLED display.

3. The AMOLED display drive method according to claim 1, wherein the preset region is an arbitrary region in the AMOLD display.

4. An AMOLED display drive circuit, employed to drive an AMOLED display, wherein the AMOLED display drive circuit comprises:
a detection unit, employed for detecting whether a gray scale of a preset region in the AMOLED display is larger than a preset gray scale, and detecting whether pixel amounts corresponded with a width and a length of the preset region are larger than preset pixel amounts;
a calculation unit, calculating a condition that a threshold voltage of each drive thin film transistor of the preset region changes along with time in a preset duration as the gray scale of the preset region in the AMOLED display is larger than the preset gray scale, and both the pixel amounts corresponded with the width and the length of the preset region are larger than the preset pixel amounts;
a compensation unit, employed for compensating a data signal loaded to the thin film transistor according to the condition that the threshold voltage of the drive thin film transistor of the preset region changes along with time in the preset duration to make a variation of the data signal loaded to the drive thin film transistor along with time equal to a variation of the threshold voltage of the drive thin film transistor along with time;
a drive unit, employed for using the data signal after being compensated to drive the AMOLED display.

5. The AMOLED display drive circuit according to claim 4, wherein as the gray scale of the preset region in the AMOLED display is smaller than or equal to the preset gray scale, or the amount corresponded with the width of the preset region is smaller than or equal to the preset pixel amount, or the amount corresponded with the length of the preset region is smaller than or equal to the preset pixel amount, the data signal is not required to be compensated by further employing the drive unit, and the data signal is used to drive the AMOLED display.

6. The AMOLED display drive circuit according to claim 4, wherein the preset region is an arbitrary region in the AMOLD display.

7. An AMOLED display device, wherein the AMOLED display device comprises an AMOLED display drive circuit, and the AMOLED display drive circuit is employed to drive an AMOLED display, and the AMOLED display drive circuit comprises:
a detection unit, employed for detecting whether a gray scale of a preset region in the AMOLED display is larger than a preset gray scale, and detecting whether pixel amounts corresponded with a width and a length of the preset region are larger than preset pixel amounts;
a calculation unit, calculating a condition that a threshold voltage of each drive thin film transistor of the preset region changes along with time in a preset duration as the gray scale of the preset region in the AMOLED display is larger than the preset gray scale, and both the pixel amounts corresponded with the width and the length of the preset region are larger than the preset pixel amounts;
a compensation unit, employed for compensating a data signal loaded to the thin film transistor according to the condition that the threshold voltage of the drive thin film transistor of the preset region changes along with time in the preset duration to make a variation of the data signal loaded to the drive thin film transistor along with time equal to a variation of the threshold voltage of the drive thin film transistor along with time;
a drive unit, employed for using the data signal after being compensated to drive the AMOLED display.

8. The AMOLED display according to claim 7, wherein as the gray scale of the preset region in the AMOLED display is smaller than or equal to the preset gray scale, or the amount corresponded with the width of the preset region is smaller than or equal to the preset pixel amount, or the amount corresponded with the length of the preset region is smaller than or equal to the preset pixel amount, the data signal is not required to be compensated, and the data signal is used to drive the AMOLED display.

9. The AMOLED display according to claim 7, wherein the preset region is an arbitrary region in the AMOLD display.
